(19) United States
(12) Patent Application Publication
(10) Pub. No.: US 2026/0322198 A1
(43) Pub. Date: Oct. 15, 2026

(54) ROTOR WITH OIL-CONDUCTING GEOMETRY

(71) Applicant: MAGNA Powertrain GmbH & Co KG, Lannach (AT)

(72) Inventors: Joachim HANNER, Haid (AT); Viktor RACZ, Ernsthofen (AT)

(21) Appl. No.: 19/634,174

(22) Filed: Mar. 31, 2026

(30) Foreign Application Priority Data
Apr. 10, 2025 (DE) 102025114289.0

(51) Int. Cl. H02K 1/32

(52) U.S. Cl. CPC H02K 1/32

(57) ABSTRACT

A rotor, in particular for an electric machine in a motor vehicle, comprising a rotor shaft (1) and a rotor package (2) surrounding the rotor shaft (1), wherein a star disc (3) is arranged at at least one axial end of the rotor package (2) such that a base element (4) of the star disc (3) is arranged between the axial end of the rotor package (2) and a rotor winding head (5), wherein at least one first oil channel (6) is routed in the rotor to the axial end of the rotor package (2), wherein at least one second oil channel (7), which is fluidically connected to the first oil channel (6), is routed radially outward toward the radially inner end of the rotor winding head (5), wherein at the end of the second oil channel (7) an oil guide geometry (8) is formed on the star disc (3), wherein the oil guide geometry (8) comprises a first oil guide section (9) that protrudes axially outward from the radially inner end of the rotor winding head (5) at a radially inner position, such that oil flows from the end of the second oil channel (7) to the axial outer side (5.1) of the rotor winding head (5), wherein the oil guide geometry (8) comprises a second oil guide section (10) that protrudes axially outward from the radially inner end of the rotor winding head (5) at a radially inner position to a lesser extent than the first oil guide section (9) or does not protrude outward at all, so that oil flows from the end of the second oil channel (7) to the axial inner side (5.2) of the rotor winding head (5).

### CROSS-REFERENCE TO RELATED APPLICATIONS

This application claims priority to German Application No. DE 102025114289.0, filed on Apr. 10, 2025. The entire disclosure of the above application is incorporated herein by reference.

### FIELD OF THE INVENTION

The present invention relates to a rotor, in particular for an electric machine in a motor vehicle, comprising an oil guide geometry.

### BACKGROUND OF THE INVENTION

It is known that electric machines, such as drive motors for motor vehicles, can use a rotor comprising a radially inner rotor shaft and a rotor package that is arranged radially around the rotor shaft and rotationally fixed to the rotor shaft. The rotor package may be constituted by a stack of rotor sheets.

Such a rotor package can accommodate windings that form rotor winding heads (also referred to as “end windings” or “winding overhang”) at the axial ends of the rotor package (also referred to as “rotor core” or “rotor stack”). It is known that the rotor winding heads of such rotors heat up during operation and can be cooled, in particular by means of oil, for example through direct oil spray cooling or oil wetting of the rotor winding heads.

However, it is difficult to cool the rotor winding head sufficiently well. To dissipate waste heat generated in a rotor, it is a known measure to provide cooling channels in the rotor through which a cooling fluid, in particular oil, can flow. At the axial end of the rotor, the rotor winding heads can be cooled by the oil flowing through the rotor's cooling channels. However, such measures have not yet been able to ensure the cooling of the winding heads to a satisfactory degree.

As is known, star discs are used in electrically excited (also referred to as “current excited”) machines to mechanically support the winding heads of the rotor against high centrifugal forces during rapid rotation of the rotor. Such star discs are arranged at the axial ends of the rotor. One side of the star disc is usually adjacent to the rotor package. The rotor windings, in particular the rotor winding heads, run along the other side of the star disc.

### SUMMARY OF THE INVENTION

It is an object of the invention to improve a rotor, in particular for an electric machine in a motor vehicle, in this respect, and in particular to provide a rotor whose rotor winding heads can be cooled simply and efficiently.

This object is achieved by a rotor, in particular for an electric machine in a motor vehicle, comprising a rotor shaft and a rotor package surrounding the rotor shaft, wherein a star disc is arranged at at least one axial end of the rotor package such that a base element of the star disc is arranged between the axial end of the rotor package and a rotor winding head, wherein at least one first oil channel is routed in the rotor to the axial end of the rotor package, wherein at least one second oil channel, which is fluidically connected to the first oil channel, is routed radially outward toward the radially inner end of the rotor winding head, wherein at the end of the second oil channel an oil guide geometry is formed on the star disc, wherein the oil guide geometry comprises a first oil guide section that protrudes axially outward from the radially inner end of the rotor winding head at a radially inner position, so that oil flows or is guided from the end of the second oil channel to the axial outer side of the rotor winding head, wherein the oil guide geometry comprises a second oil guide section that protrudes axially outward from the radially inner end of the rotor winding head at a radially inner position to a significantly lesser extent than the first oil guide section or does not protrude outward at all, so that oil flows or is guided from the end of the second oil channel to the axial inner side of the rotor winding head.

According to the invention, a rotor has an oil guide structure or oil guide geometry that comprises both a type of extension, finger, or rib, namely a first oil guide section, which guides the cooling fluid, namely oil, to the axial outer side of the rotor winding head, as well as a second oil guide section, in particular a missing or significantly shorter extension, finger, or rib, which is designed to guide the same oil from the second oil channel leading radially outward to the axial inner side of the rotor winding head.

In this way, with a simple yet doubly effective oil guide geometry, in particular with a suitable finger structure on the star disc, both the axially inner and outer surfaces of a rotor winding head can be cooled simultaneously. This directly cools more surfaces of the rotor winding head and achieves an overall improvement in the cooling of the rotor winding head. The continuous power output of the electric motor can thereby be increased.

Further developments of the invention are described in the dependent claims, the description, and the accompanying drawings.

Preferably, a boundary wall extending radially outward is formed opposite the end of the first oil guide section, so that oil flows from the end of the second oil channel between the first oil guide section and the boundary wall to the axial outer side of the rotor winding head, wherein the boundary wall is preferably formed by the star disc.

Preferably, the rotor has rotor poles, and the oil guide geometry is formed on the star disc at a rotor pole such that the first oil guide section and the second oil guide section are associated with the same rotor pole, so that oil flows from the end of the second oil channel to the axial outer side and to the axial inner side of the rotor winding head of the same rotor pole.

Preferably, the oil guide geometry is formed on the star disc at each rotor pole such that the respective first oil guide section and the respective second oil guide section are associated with the respective rotor pole, so that oil flows from the end of the respective second oil channel to the axial outer side and to the axial inner side of the rotor winding head of the respective rotor pole.

Preferably, at least one first oil channel at each rotor pole in the rotor is routed to the axial end of the rotor package, and each first oil channel is fluidically connected to at least one second oil channel of the respective rotor pole that leads radially outward. At each rotor pole, a separate axial oil supply is thus provided via an associated first oil channel.

Preferably, the oil guide geometry is formed integrally by the star disc. In another embodiment, the oil guide geometry is formed as a separate component on the star disc, preferably attached to the star disc.

Preferably, the first oil guide section—thus preferably the finger or rib—protrudes axially outward over at least 50%, preferably over at least 70% or at least 90%, of the axial width of the rotor winding head.

The second oil guide section—essentially the missing or greatly shortened finger or rib—preferably protrudes axially outward over at most 20% of the axial width of the rotor winding head. Preferably, the second oil guide section is formed by the base element of the star disc and does not protrude at all beyond the width of the base element in the radial region between the rotor package and the axial inner side of the rotor winding head—or at least less than 100% of this width between the rotor package and the axial inner side of the rotor winding head.

Preferably, a third oil channel, which is fluidically connected to the second oil channel via the oil guide geometry, is routed radially outward between the rotor package and the axial inner side of the rotor winding head, so that oil flows or is guided through the third oil channel on the axial inner side of the rotor winding head to the radial outer side of the rotor winding head, wherein the third oil channel particularly preferably terminates radially at the radial outer side of the rotor winding head.

Preferably, a fourth oil channel, which is fluidically connected to the second oil channel via the oil guide geometry, is routed radially outward along the axial outer side of the rotor winding head, so that oil flows or is guided through the fourth oil channel on the axial outer side of the rotor winding head to the radial outer side of the rotor winding head, wherein the fourth oil channel preferably terminates radially at the radial outer side of the rotor winding head.

The fourth oil channel is preferably bounded axially on the outside by an end cap.

### BRIEF DESCRIPTION OF THE DRAWINGS

The invention is described below by way of example with reference to the drawings.

FIG. 1 is a schematic sectional view of a rotor according to the invention in the region of the oil guide geometry.

FIG. 2 is a three-dimensional sectional view of a rotor according to the invention.

FIG. 3a is a front view of the rotor according to the invention as shown in FIG. 2.

FIG. 3b is a sectional side view of the rotor according to the invention as shown in FIG. 3a in the region of a first oil guide section.

FIG. 3c is a side view of the rotor according to the invention as shown in FIG. 3a with an end cap attached.

FIG. 3d is a sectional side view of the rotor according to the invention as shown in FIG. 3a in the region of a second oil guide section.

FIG. 4 is a three-dimensional schematic representation of a rotor according to the invention in the region of a second oil guide section, as shown in FIG. 3d.

FIG. 5 is a three-dimensional schematic representation of a rotor according to the invention in the region of a first oil guide section, as shown in FIG. 3b.

FIG. 6 is a three-dimensional schematic representation of a rotor according to the invention in the region of the oil guide geometry.

### DETAILED DESCRIPTION OF THE INVENTION

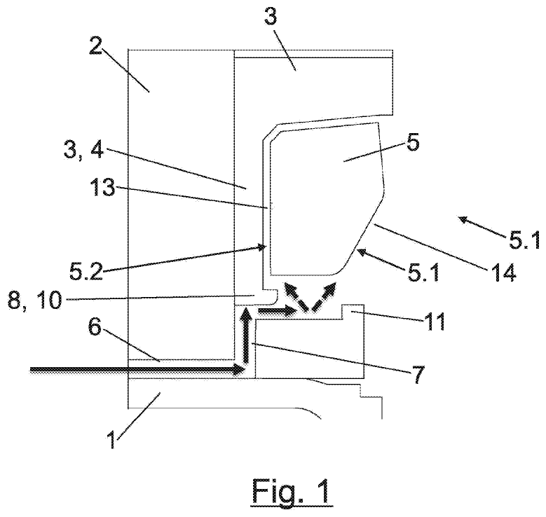

FIG. 1 shows a rotor according to the invention in the region of the oil guide geometry 8 of a star disc 3, for supplying oil to the axial outer side 5.1 and simultaneously to the axial inner side 5.2 of a rotor winding head 5.

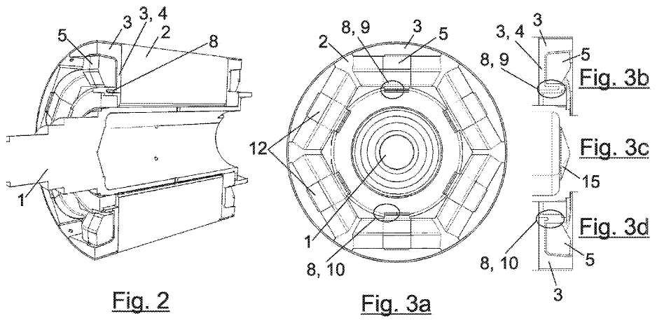

The same rotor is shown in three dimensions as a cross-section in FIG. 2 and viewed from the front in FIG. 3a.

The rotor comprises a rotor shaft 1 and a rotor package 2 surrounding the rotor shaft 1. A star disc 3 is arranged at each of the two axial ends of the rotor package 2 such that a plate-shaped base element 4 of the star disc 3 is positioned between the axial end of the rotor package 2 and a rotor winding head 5. A first oil channel 6 is routed in the rotor to the axial end of the rotor package 2. A second oil channel 7, which is fluidically connected to the first oil channel 6, is routed radially outward, toward the radially inner end of the rotor winding head 5.

At the end of the second oil channel 7, an oil guide geometry 8 is formed on the star disc 3. The oil guide geometry 8 comprises a first oil guide section 9 (see FIG. 3b and FIG. 5), which protrudes axially outward from the radially inner end of the rotor winding head 5 at a radially inner position and thus forms a sort of “finger,” so that oil is guided from the end of the second oil channel 7 to the axial outer side 5.1 of the rotor winding head 5. The first oil guide section 9 protrudes axially outward over at least 50% of the axial width of the rotor winding head 5, so that the oil is guided into the region of the outer side 5.1 of the rotor winding head 5.

A fourth oil channel 14 (see FIG. 5), which is fluidically connected to the second oil channel 7 via the oil guide geometry 8, is routed radially outward along the axial outer side 5.1 of the rotor winding head 5, so that oil flows through the fourth oil channel 14 on the axial outer side 5.1 of the rotor winding head 5 to the radial outer side of the rotor winding head 5. The fourth oil channel 14 terminates radially at the radial outer side of the rotor winding head 5.

As shown in FIG. 3d, the fourth oil channel 14 is bounded axially on the outside by an end cap 15 or a similar covering component.

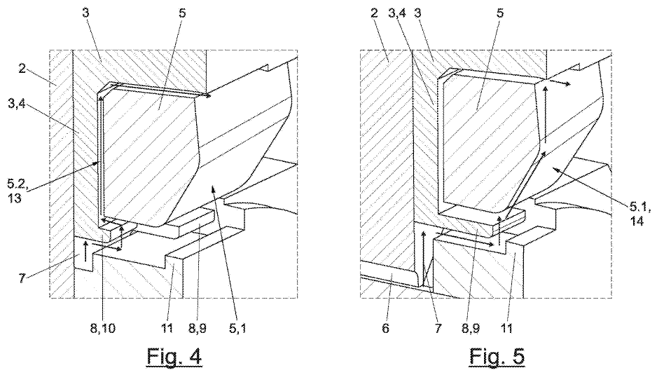

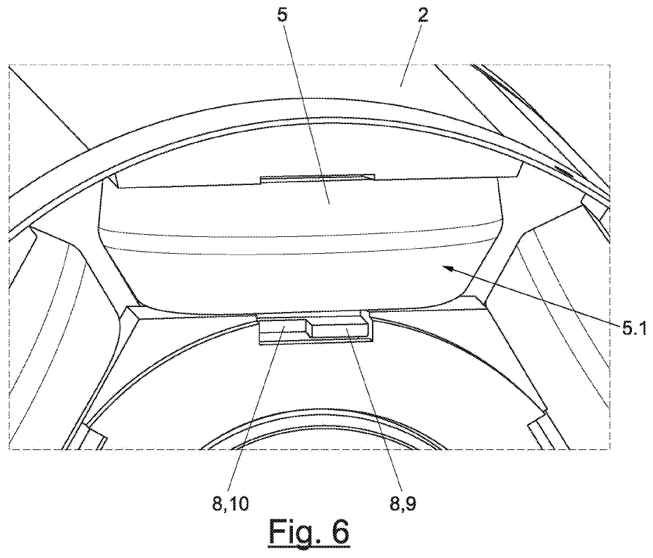

The oil guide geometry 8 comprises a second oil guide section 10 (see FIG. 1, FIG. 3d, and FIG. 4), which protrudes axially outward from the radially inner end of the rotor winding head 8 at a radially inner position to a lesser extent than the first oil guide section 9—and thus forms a significantly shorter “finger”—or does not protrude outward at all, so that oil is guided from the end of the second oil channel 7 to the axial inner side 5.2 of the rotor winding head 5.

A third oil channel 13 (see FIG. 4), which is fluidically connected to the second oil channel 7 via the oil guide geometry 8, is routed radially outward between the rotor package 2 and the axial inner side 5.2 of the rotor winding head 5, so that oil flows through the third oil channel 13 on the axial inner side 5.2 of the rotor winding head 5 to the radial outer side of the rotor winding head 5. The third oil channel 13 terminates radially at the radial outer side of the rotor winding head 5.

A boundary wall 11 extending radially outward is formed opposite the end of the first oil guide section 9, so that oil flows from the end of the second oil channel 7 between the first oil guide section 9 and the boundary wall 11 to the axial outer side 5.1 of the rotor winding head 5, wherein the boundary wall 11 is preferably formed by the star disc 3.

Such a configuration of an oil guide geometry 8 is provided at both axial ends of the rotor.

The rotor has several, for example six, rotor poles 12, and the oil guide geometry 8 is formed on the star disc 3 at a rotor pole 12 such that both the first oil guide section 9 and the second oil guide section 10 are associated with the same rotor pole 12, so that oil flows from the end of the second oil channel 7 to the axial outer side 5.1 and to the axial inner side 5.2 of the rotor winding head 5 of the same rotor pole 12.

The oil guide geometry 8 is formed—as shown in FIG. 3a—on the star disc 3 at each rotor pole 12 such that the respective first oil guide section 9 and the respective second oil guide section 10 are associated with the respective rotor pole 12, so that oil flows from the end of the respective second oil channel 7 to the axial outer side 5.1 and to the axial inner side 5.2 of the rotor winding head 5 of the respective rotor pole 12.

The oil guide geometry 8 is formed integrally by the star disc 3.

FIG. 4 is a three-dimensional representation of a rotor according to the invention in the region of a second oil guide section 10. FIG. 5 is a three-dimensional representation of the same rotor in the region of a first oil guide section 9. The path of the oil along the third oil channel 13 (FIG. 4) and the fourth oil channel 14 (FIG. 5) is indicated by arrows pointing in the direction of flow.

Oil is thus transported to the ends of a rotor sheet package 2 within the rotor. This is possible via the rotor shaft, in oil channels between the shaft and the sheet package, or directly within the sheet package. The oil can then flow into the star disc 3 through radially arranged channels 7.

The inflow occurs separately to both rotor winding heads and to each rotor pole 12. Here, an axial finger structure 9, 10 is used to divide the oil into two flow paths. The finger structure 9, 10 is formed by at least two rib-like components—separate or integrated—that protrude axially from the star disc 3. These can divide the oil depending on the direction of rotor rotation. Through the first path, oil flows through a radial oil channel 13 between the star disc 3 and the inner surface 5.2 of the rotor winding head. This oil channel terminates at the outer diameter of the rotor winding head 5. The second path serves to wet the outer surface 5.1 of the rotor winding head. This is possible without an end cap 15; however, an end cap 15 may be used to form a closed oil channel 14. This flow path also terminates at the outer diameter of the rotor winding head 5.

1. A rotor, in particular for an electric machine in a motor vehicle, comprising a rotor shaft and a rotor package surrounding the rotor shaft, wherein a star disc is arranged at at least one axial end of the rotor package such that a base element of the star disc is arranged between the axial end of the rotor package and a rotor winding head, wherein at least one first oil channel is routed in the rotor to the axial end of the rotor package,
wherein at least one second oil channel, which is fluidically connected to the first oil channel, is routed radially outward toward the radially inner end of the rotor winding head, wherein at the end of the second oil channel an oil guide geometry is formed on the star disc, wherein the oil guide geometry comprises a first oil guide section that protrudes axially outward from the radially inner end of the rotor winding head at a radially inner position, so that oil flows from the end of the second oil channel to the axial outer side of the rotor winding head, wherein the oil guide geometry comprises a second oil guide section that protrudes axially outward from the radially inner end of the rotor winding head at the radially inner position to a lesser extent than the first oil guide section or does not protrude outward at all, so that oil flows from the end of the second oil channel to the axial inner side of the rotor winding head.

2. The rotor according to claim 1,
wherein a boundary wall extending radially outward is formed opposite the end of the first oil guide section, so that oil flows from the end of the second oil channel between the first oil guide section and the boundary wall to the axial outer side of the rotor winding head, wherein the boundary wall is preferably formed by the star disc.

3. The rotor according to claim 1,
wherein the rotor has rotor poles and the oil guide geometry is formed on the star disc at a rotor pole such that the first oil guide section and the second oil guide section are associated with the same rotor pole, so that oil flows from the end of the second oil channel to the axial outer side and to the axial inner side of the rotor winding head of the same rotor pole.

4. The rotor according to claim 3,
wherein the oil guide geometry is formed on the star disc at each rotor pole such that the respective first oil guide section and the respective second oil guide section are associated with the respective rotor pole, so that oil flows from the end of the respective second oil channel to the axial outer side and to the axial inner side of the rotor winding head of the respective rotor pole.

5. The rotor according to claim 3,
wherein at least one first oil channel at each rotor pole in the rotor is routed to the axial end of the rotor package, and each first oil channel is fluidically connected to at least one second oil channel of the respective rotor pole that leads radially outward.

6. The rotor according to claim 1,
wherein the oil guide geometry is formed integrally by the star disc, or
wherein the oil guide geometry is formed as a separate component on the star disc, preferably attached to the star disc.

7. The rotor according to claim 1,
wherein the first oil guide section protrudes axially outward over at least 50%, preferably over at least 70%, of the axial width of the rotor winding head, wherein the first oil guide section preferably forms a finger and/or a rib.

8. The rotor according to claim 1,
wherein the second oil guide section protrudes axially outward over at most 20% of the axial width of the rotor winding head, or wherein the second oil guide section is formed by the base element of the star disc and does not protrude beyond the width of the base element in the radial region between the rotor package and the axial inner side of the rotor winding head, or at least less than 100% of this width between the rotor package and the axial inner side of the rotor winding head.

9. The rotor according to claim 1,
wherein a third oil channel, which is fluidically connected to the second oil channel via the oil guide geometry, is routed radially outward between the rotor package and the axial inner side of the rotor winding head, so that oil flows through the third oil channel on the axial inner side of the rotor winding head to the radial outer side of the rotor winding head, wherein the third oil channel preferably terminates radially at the radial outer side of the rotor winding head, and/or
wherein a fourth oil channel, which is fluidically connected to the second oil channel via the oil guide geometry, is routed radially outward along the axial outer side of the rotor winding head, so that oil flows through the fourth oil channel on the axial outer side of the rotor winding head to the radial outer side of the rotor winding head, wherein the fourth oil channel preferably terminates radially at the radial outer side of the rotor winding head.

10. The rotor according to claim 9,
wherein the fourth oil channel is bounded axially on the outside by an end cap.
